(19) United States
(12) Patent Application Publication
(10) Pub. No.: US 2025/0000632 A1
(43) Pub. Date: Jan. 2, 2025

(54) METHOD FOR THE STUNNING BY GAS AND SLAUGHTER BY DECOMPRESSION OF ANIMALS

(71) Applicant: CATTARUZZI INTERNATIONAL S.R.L., San Zeno Naviglio (Brescia) (IT)

(72) Inventor: Giacomo CATTARUZZI, San Zeno Naviglio (Brescia) (IT)

(21) Appl. No.: 18/579,885

(22) PCT Filed: Jul. 11, 2022
(86) PCT No.: PCT/IB2022/056380

§ 371 Date: Jan. 19, 2024

(30) Foreign Application Priority Data
Jul. 21, 2021 (IT) 102021000019343

(51) Int. Cl. A61D 7/04

(52) U.S. Cl. CPC A61D 7/04

(57) ABSTRACT

A method for stunning and killing animals, suitable for poultry, pigs, chinchillas, mustelids, rabbits and fur-bearing animals is provided. The method involves introducing live animals to be slaughtered into a sealed chamber of a slaughter plant, adding to the sealed chamber at least one gas suitable for causing the animals to lose consciousness, performing a stunning stop so that the animals in the sealed chamber are at least partially stunned, creating a vacuum inside the sealed chamber until a predefined killing pressure is achieved, performing a killing stop so that the stunned animals in the sealed chamber are killed, opening the sealed chamber and extracting the killed animals. The gas insertion step may be preceded by a pre-suction step of air from the sealed chamber. The method minimizes damages caused by convulsive phenomena occurring in traditional slaughter methods.

The object of the present invention is a method for stunning and killing animals, typically poultry, that minimizes the convulsive phenomena typical of all killing procedures currently on the market.

The procedures currently used are:

GAS method, which involves using gases (such as carbon dioxide or carbon dioxide associated with inert gases, inert gases, carbon monoxide or carbon monoxide associated with inert gases) to be introduced into pits, tunnels or containers, wherein the animals to be slaughtered are contained. This method, in order to avoid convulsive phenomena, involves the use of a considerable amount of gas and very long periods of exposure to the gas by the animals to be slaughtered;

L.A.P.S. Method (Low Atmospheric Pressure Stunner) which provides for gradual decompression from atmospheric pressure to the slaughter pressure within a sealed chamber containing the animals to be slaughtered. An example of such method is described in the documents EP 2 441 331 B1 and EP 2 055 191 B1 in the name of the holder. This system provides for a significant reduction in pressure, a shorter slaughter cycle and no use of gas. However, the vacuum during the initial step of the slaughter process is critical for animals, because, at a certain pressure level between 53 kPa (400 torr) and 21.5 kPa (160 torr), in poultry, spontaneous convulsions occur. These phenomena involve hematomas, fractures and/or disarticulations in those animals subjected to slaughter, in particular at the wings in the case of birds (chickens, hens, guinea fowl, turkeys, pigeons, quail, etc.) and especially in larger specimens;

L.A.P.S+GAS method, which provides for a first step of decompression from atmospheric pressure to a stunning pressure that is greater than the slaughter pressure normally used with the traditional L.A.P.S. method, and a second step of the addition of gas within the chamber and the maintenance of the same for a period of time necessary to achieve the slaughtering of the animals. This system is described in the document EP 3 310 178 A1 on behalf of the holder and, although it makes it possible to reduce the amount of gas to be introduced into the chamber compared to a traditional GAS method, it does not make it possible to reduce the duration of the slaughter cycle nor the occurrence of spontaneous convulsions.

An unfavorable effect common to all three known methodologies cited above occurs during the slaughter step wherein significant convulsive phenomena occur in the animals. In order to attempt to reduce these convulsive phenomena with the GAS method it is necessary to extend the duration of the slaughter cycle, while in the L.A.P.S and L.A.P.S+GAS methods these convulsive phenomena are not attenuable because they occur spontaneously when a pressure lower than 53 kPa (400 torr) is reached within the sealed chamber.

In birds, especially in larger specimens, in particular at the wings, these phenomena involve hematomas, fractures and/or disarticulations. These phenomena lead to a reduction in the quality of the animals slaughtered and consequently economic damage to the slaughterers, who often avoid using the above methods.

The object of the present invention is to provide a method for stunning and killing of animals which, in compliance with the recommended standards for animal welfare, minimizes the typical convulsive phenomena of the slaughter procedure by means of pressure reduction (L.A.P.S. and L.A.P.S.+GAS methods) and which reduces the slaughter time of the GAS method.

This purpose is achieved by means of a method for stunning and killing in accordance with the present invention which provides for “anesthetizing”, rendering the animals unconscious, by means of the use of gases introduced into the chamber, and then slaughtering them by means of reducing the pressure in aspirating the air from the chamber itself.

The purpose of this invention is to provide a stunning and killing method that makes it possible to obtain high levels of product quality in maintaining a high usage flexibility, reduced slaughter cycle times, reduced gas consumption and production costs in general, such as to best meet all of the needs of the market.

This purpose is achieved by means of a method for stunning and killing of animals according to claim 1. The dependent claims describe preferred or advantageous embodiments of the method.

The features and advantages of the stunning and killing method according to the present invention may be more apparent from the description below and the exemplary embodiments thereof, given as an indication and not as a limitation.

The stunning and killing method according to this invention is performed in a facility for the killing of animals for slaughter comprising a chamber, preferably cylindrical, with at least opening for the introduction of live animals and the extraction of the slaughtered animals.

The chamber has an inlet opening for the introduction of live animals and an outlet opening for the extraction of the slaughtered animals; each opening is equipped with respective sealing device that is capable of hermetically sealing these openings.

The chamber into which the animals to be slaughtered are inserted is equipped with a balancing valve, capable of balancing the pressure inside the chamber itself with the pressure outside the chamber (atmospheric pressure) at the end of the slaughter cycle.

The plant includes air aspiration means that are communicating with this chamber in order to remove air therefrom. The air aspiration means are capable of creating a depression inside the chamber in such a way as to reach an internal pressure that is lower than the external pressure. The term, external pressure, refers to the effective pressure outside the chamber, a pressure that depends on the altitude of the site where the plant is located.

The plant also comprises gas injection means for injecting a gas into the chamber where the animals to be slaughtered are housed. The gas is injected the chamber before the slaughtering step in order to obtain at least partial anesthetization of the animals to be slaughtered.

The plant comprises a control unit that is suitable for controlling and synchronizing the air aspiration means and gas injection means, all of the valves and also the chamber closure devices. The control unit is equipped with a user interface comprising setting means that are suitable for allowing the operator to set the percentage of gas to be introduced into the chamber, the internal pressure values to be achieved within the chamber and the values of time animals stay inside the chamber.

The control unit comprises a PLC, advantageously a display connected to the PLC, and a device that records all factors that are indicative of the process, such as the pressure values, the percentage of gas present within the chamber, the percentage of oxygen present within the chamber and, preferably, the duration of each step of the cycle.

The plant comprises a probe that reads the pressure inside the chamber and the pressure variations inside the chamber, and that sends these values to the control unit, and preferably to the display connected to the PLC and the recorder.

Preferably, the plant comprises a programmed or programmable pressure switch based on pressure. The control unit is therefore capable of, taking into account the correct starting value (atmospheric pressure inside the chamber), transmitting to the air aspiration means the correct pressure difference value (A pressure) in such a way as to perform the correct depression within the chamber until the desired pressure is reached.

Advantageously, the control unit controls the gas injection means on the basis of the pressure values inside the chamber as detected by the probe. Preferably, the plant comprises a pressure gauge and/or vacuum gauge, and a transducer, capable of controlling the pressure and pressure variations within the chamber.

The control unit therefore reads the reduction in pressure that is generated in the chamber when the air aspiration means are activated and the increase in pressure that is generated in the chamber when the gas injection is activated.

The plant comprises detection means of the vital activity of the animals within the chamber. For example, the detection means comprise at least one camera, for example infrared, which records the steps of the cycle for stunning and killing of the animals inside the chamber. These detection means therefore make it possible to ascertain the presence or absence of convulsive phenomena and the progress thereof during the steps of the process for slaughtering the animals.

The method for the stunning and killing of animals according to the present invention is thus implemented.

The animals are introduced into the chamber, which is closed sealed.

The animals may be introduced locked up within a single cage, or else in a succession of smaller cages, or else loose.

At atmospheric pressure, a certain amount of gas is inserted into the chamber such as to anesthetize, at least partially, that is to say stun, the animals placed inside the chamber. The gas is maintained for a certain period of time. The loss of consciousness of the animals occurs after the insertion of the gas and after a certain interval of time, depending on the type of animal. Therefore, a stunning stop of between 10 seconds and 10 minutes is performed.

For example, if a pre-aspiration step is performed, better described below, the stunning stop is between 30 seconds and 2 minutes.

For example, if a pre-aspiration is not performed, the stunning stop is between 10 seconds and 2 minutes.

The gas is for example carbon dioxide (CO₂), or a mixture containing carbon dioxide associated with inert gases, or a mixture of inert gases such as nitrogen or argon or carbon monoxide (CO). It should be noted that carbon dioxide (CO₂) turns out to have an anesthetic effect on animals. Therefore, the step of injecting carbon dioxide into the chamber causes at least partial loss of consciousness of the animal, reducing the convulsions.

The percentage of gas to be injected is between 10% and 60% of the volume of air within the chamber in the case of carbon dioxide (CO₂) or carbon dioxide associated with inert gases. Preferably, the percentage of gas to be injected is between 20% and 50%.

For example, if a pre-aspiration step is performed, better described below, the percentage of gas to be injected is between 30% and 50%.

For example, if a pre-aspiration step is not performed, the percentage of gas to be injected is between 20% and 40%.

In the case of carbon monoxide (CO) or carbon monoxide with a mixture of inert gases such as argon and nitrogen, it must be more than 1% of the volume of air within the chamber.

Since the chamber is a sealed chamber, after the insertion of the gas, an increase in pressure proportional to the volume of the gas inserted occurs within the chamber. This increase in pressure makes it possible to accurately measure the amount of gas inserted because the pressure and volume are directly proportional.

The purpose and effect of the injection of the gas into the chamber wherein the animals are housed is not to slaughter them but to bring them into a state of unconsciousness due to the “anesthetic” effect of the gas, in particular CO₂, before convulsive phenomena occur, and thus to prevent the typical qualitative damage to the animals, in particular to birds. Only then does the method proceed with the slaughtering step.

Once a state of unconsciousness of the animals introduced into the chamber has been reached, the mixture of air and gas present within the chamber is aspirated, within a given period of time, until a slaughtering pressure of between 33 kPa (250 Torr) and 12 kPa (90 Torr) is reached. In a preferred example, a slaughtering pressure of 21 kPa (160 Tor) is reached.

The method involves stopping at the slaughter pressure for a certain interval of time that is suitable for slaughtering all animals by means of hypoxia, that is to say due to a lack of oxygen which, as required by European legislation, must be in a percentage of less than 5% of the volume of the air contained in the chamber.

The method therefore provides for a slaughtering stop of between 10 seconds and 180 seconds.

Advantageously, due to the slaughtering step by means of aspiration, most of the CO₂ present within the chamber is evacuated and sent into the atmosphere by means of a ducted conduit right at this step of the slaughter cycle. This avoids the dispersion of CO₂ into the area around the plant when the chamber is opened for the extraction of the animals. This makes it possible to further reduce the cycle times, because it is not necessary to proceed with a step that is dedicated to the removal of the CO₂ from the chamber at the end of the cycle, while those animals that have already been slaughtered are still present therein. In fact, for reasons of meat quality and to facilitate the bleeding step, it is advisable that the slaughtered animals are butchered as soon as possible without remaining in the chamber for a long period of time.

Advantageously, in one embodiment, in order to reduce the stunning times and the amount of gas to be introduced into the chamber, the gas injection step is preceded by a pre-aspiration step of the air from the closed seal chamber. In this example, therefore, the pre-aspiration step involves aspirating air until an internal chamber pressure is obtained of between 99 kPa (750 Torr) and 26 kPa (200 Torr), preferably of between 87 kPa (650 Torr) and 60 kPa (450 Torr). In a preferred example, an internal pressure equal to around 67.5 kPa (500 Tor) is reached. The exact pressure value to be reached is to be defined during the plant testing step, based on the type of subject (chickens, turkey hens, guinea fowl, pigeons, mustelids, chinchillas, pigs), the weight of the subjects and the manifestation of convulsive phenomena during the tests. Once the required pressure within the chamber has been reached, the gas is inserted in order to anesthetize, at least partially, that is to say stun, the animals placed inside the chamber. The gas is maintained period of for a certain of time. Once a state unconsciousness of the animals introduced into the chamber is reached, the mixture of air and gas present within the chamber is aspirated, as described above, until the animals are slaughtered.

Note that in the method for stunning and killing of animals according to the present invention, the amount of gas introduced into the chamber serves only as an anesthetic to bring the animals into a state of unconsciousness in order to eliminate all convulsive effects and related damage regarding the quality of the meat, while the actual slaughter is achieved, according to European legislation, by means of a reduction in the percentage of oxygen (below 5% of the air volume) after the pressure reduction step inside the chamber. The reduction of pressure determines in fact a reduction in the volume of air present within the chamber and therefore a reduction in the amount of oxygen present within the chamber.

After the opening of the chamber, the unloading of the dead animals and the reintegration with new live animals, the cycle is repeated.

In summary, the method for stunning and killing of animals according to the present invention involves placing the animals in a chamber, sealed closed, and then inserting a certain amount of gas (preferably CO₂) in order to “anesthetize” them, to render them unconscious and reduce the convulsive effects that are typical of the LAPS slaughter methodology. After the stunning step by means of inserting the gas, the actual slaughter step is performed by means of aspirating the mixture of air and gas in order to reduce the pressure up to a minimum established value that varies according to the weight and type of animal to be slaughtered. The slaughter step makes it possible to safely evacuate the mixture of air and gas present within the chamber.

The method for stunning and killing of animals according to this invention that is suitable for poultry, pigs, chinchillas, mustelids, rabbits and fur-bearing animals involves the following steps:
introducing live animals to be slaughtered into a closed chamber of a slaughtering plant;
adding to the chamber at least one gas suitable for causing the animals to lose consciousness,
carrying a stunning stop out such that the animals in the chamber are at least partially stunned;
carrying the depression out within the chamber in such a way as to reach a predefined slaughtering pressure;
carrying a slaughter stop out in order to ensure that the animals in the chamber have been slaughtered;
opening the chamber and extracting the slaughtered animals.

In one embodiment, the method anticipates, after the step of introducing the animals into the chamber and before the step of adding at least one stunning gas to the chamber, a pre-aspiration step that involves:
carrying a depression out within the chamber in such a way as to reach a predefined internal pressure.

### EXAMPLES OF THE STUNNING AND KILLING CYCLE

### Composition of the Atmosphere (Dry Air)

Nitrogen: 78%
Oxygen: 21%
Argon 0.83%
Carbon dioxide: 0.03%
Other components in smaller quantities

### Example 1

10 chickens are introduced into a test chamber, each weighing about 3 kg. The pressure inside the chamber corresponds to atmospheric pressure of approximately (101 kPa-760 Torr).

In the chamber, sealed closed, a quantity of gas is inserted, in this case carbon dioxide (CO₂), equal to about 30% of the volume of air present within the chamber. To accurately determine the amount of gas to be injected into the chamber, the volume and pressure being directly proportional, gas is introduced until the pressure in the chamber increases by 30%, that is to say until a pressure of 130 kPa (982 Torr) is reached inside the chamber.

The time taken to insert the gas into the chamber, which also affects the total duration of the slaughter cycle, varies depending on the pressure of the gas entering the chamber. In this example, CO₂ was introduced at a pressure of 3 Bar (300 kPa) over a period of about 1 minute and 20 seconds.

A stop of about 30 seconds, said stunning stop, is then performed in order to allow the CO₂ to have an anesthetic effect on the animals.

At the end of the stop, once the loss of consciousness has been reached, the slaughter step has been started. By means of a vacuum pump, a depression has been produced within the chamber to achieve a slaughter pressure of 21.5 kPa (160 Torr) in about 1 minute and 30 seconds.

Once this pressure has been reached, a stop has been made for about 40 seconds, said slaughter stop, at the end of which all of the chickens inside the chamber were dead without convulsions or the flapping of wings.

The total cycle time is therefore approximately 4 minutes.

### Example 2

10 chickens are introduced into a test chamber, each weighing about 3 kg. The pressure inside the chamber corresponds to atmospheric pressure of approximately (101 kPa-760 Torr).

Inside the chamber, sealed closed, a quantity of carbon dioxide is inserted (CO₂), equal to about 20% of the volume of air present in the chamber. To accurately determine the amount of gas to be injected into the chamber, gas has been introduced until the pressure in the chamber increased by 20%, up to a pressure of 120 kPa (900 Torr) has been reached.

The time taken to insert the gas into the chamber at a pressure of 3 Bar (300 kPa) has been approximately 60 seconds.

A stop of about 80 seconds, said stunning stop, has been then performed in order to allow the CO₂ to have an anesthetic effect on the animals.

At the end of stop, once the loss of consciousness has been reached, the slaughter step has been started. By means of a vacuum pump, a depression has been produced within the chamber such as to achieve a slaughter pressure of 21.5 kPa (160 Torr) in about 80 seconds.

Once this pressure has been reached, a stop has been made for about 40 seconds, said slaughter stop, at the end of which all of the chickens inside the chamber were dead without convulsions or flapping of wings.

The total cycle time is therefore approximately 4 minutes and 20 seconds.

This period of time is similar to the slaughter cycle used in the traditional L.A.P.S method, but the convulsions and flapping of wings resulting in damage to poultry has been avoided.

### Example 3

10 chickens are introduced into a test chamber, each weighing about 3 kg. The pressure inside the chamber corresponds to atmospheric pressure of approximately (101 kPa-760 Torr).

In the chamber, sealed closed, a pre-aspiration step is performed. By means of a vacuum pump, a depression has been created to achieve a blowdown pressure of 67.5 kPa (500 Torr) in about 20 seconds. The pre-aspiration step involves a reduction in the amount of oxygen within the chamber and at the same time an acceleration of the respiration of the subjects due to the rapid rarefaction of the air. This results in faster absorption into the lungs of the gas that may then be inserted into the chamber.

Into the chamber, a quantity of carbon dioxide (CO₂) equal to about 50% of the volume of air present in the chamber is introduced. To accurately determine the amount of gas to be injected into the chamber, gas is introduced until a pressure of 101 kPa (760 Torr) was reached. The period of time taken to insert the gas into the chamber varies depending on the pressure of the gas entering the chamber. In this example, a pressure of 3 Bar (300 kPa) over a period of about 1 minute and 30 seconds. With the insertion of gas, a further dilution of the amount of oxygen is obtained and therefore a further dilution of the oxygen in the new mixture of air and gas.

After inserting the gas, a stop is made for about 40 seconds, called stunning stop.

At the end of the stop, having ascertained the loss of consciousness of the birds, the slaughter step has been started.

By means of a vacuum pump, a depression has been produced within the chamber to achieve a slaughter pressure of 13.3 kPa (160 Torr) in about 1 minute.

At this value, a stop is made for about 30 seconds, called slaughter stop, at the end of which the all chickens inside the chamber were dead without convulsions or the flapping of wings.

The total cycle time was therefore approximately 4 minutes.

### Example 4

10 chickens are introduced into a test chamber, each weighing about 3 kg. The pressure inside the chamber corresponds to atmospheric pressure of approximately (101 kPa-760 Torr).

In the chamber, sealed closed, a pre-aspiration step is performed. By means of a vacuum pump, a depression has been created in the chamber to achieve a slaughter pressure of 67.5 kPa (500 Torr) in about 20 seconds. The pre-aspiration step involves a reduction in the amount of oxygen within the chamber and at the same time an acceleration of the respiration of the subjects due to the rapid rarefaction of the air. This results in faster absorption into the lungs of the gas that may then be inserted into the chamber.

Inside the chamber a quantity of carbon dioxide (CO₂) equal to about 30% of the volume of air present in the chamber is inserted. To accurately determine the amount of gas to be injected into the chamber, gas is introduced until a pressure of 87.7 kPa (650 Torr) was reached. The time taken to insert the gas into the chamber varies depending on the pressure of the gas entering the chamber. In this example, a pressure of 3 Bar (300 kPa) over a period of about 50 seconds. With the insertion of the gas, a further dilution of the amount of oxygen is obtained and therefore a further dilution of the oxygen in the new mixture of air and gas.

After inserting the gas, a stop is made for about 2 minutes, called stunning stop.

At the end of the stop, having ascertained the loss of consciousness of the birds, the slaughter step has been started.

By means of a vacuum pump, a depression has been created within the chamber to achieve a slaughter pressure of 13.3 kPa (160 Torr) in about 50 seconds.

At this value, a stop is made for about 30 seconds, called slaughter stop, at the end of which all chickens inside the chamber were dead without convulsions or the flapping of wings.

The total cycle time was approximately 4 minutes 30.

SUMMARY EXAMPLES TABLE

| | EXAMPLE | EXAMPLE | EXAMPLE | EXAMPLE |
|---|---|---|---|---|
| | 1 | 2 | 3 | 4 |
| Aspiration Pressure | | | 67.5 kPa | 67.5 kPa |
| Period of time required in | | | 20″ | 20″ |
| order to reach the Pre- | | | | |
| aspiration Pressure | | | | |
| % CO₂ introduced into the | 30% | 20% | 50% | 30% |
| chamber | | | | |
| Internal chamber pressure | 130 kPa | 120 kPa | 101 kPa | 87.7 kPa |
| after inserting the gas | | | | |
| Period of time required in | 1′ 20″ | 60″ | 1′ 30″ | 50″ |
| order to reach the Pressure | | | | |
| Stunning stop | 30″ | 80″ | 40″ | 2′ |
| Slaughter pressure | 21.5 kPa | 21.5 kPa | 13.3 kPa | 13.3 kPa |
| Period of time required in | 1′ 30″ | 80″ | 1′ | 50″ |
| order to reach the slaughter | | | | |
| Pressure in the chamber | | | | |
| Slaughtering stop | 40″ | 40″ | 30″ | 30″ |
| Total cycle time | 4′ | 4′ 20″ | 4′ | 4′ 30″ |

Innovatively, the method for stunning and killing of animals according to the present invention, suitable for poultry, pigs, chinchilla, mustelids, rabbits and fur-bearing animals, anticipates, unlike the other methods, initially anesthetizing the animals by means of the use of gases introduced into the chamber, thereby making it possible to avoid convulsions and the flapping of wings before the slaughter step by means of reducing the pressure by means of aspirating the air from the chamber itself. Therefore, according to the method in question, only after a certain stop period for the animals in the chamber that is suitable for “anesthetizing” them, in order to minimize convulsive phenomena, it begin the chamber begin to be decompressed until obtaining a percentage of oxygen lower than 5% and therefore the slaughter of the animals themselves as required by current EU legislation. In this invention, therefore, the amount of gas injected into the chamber serves only as an anesthetic to bring the animals into a state of unconsciousness in order to eliminate all convulsive effects and the related damage to the quality of the product. In fact, the actual slaughter only takes place at a later step, when a decompression has been carried out in the chamber and thus an aspiration of the air which causes the percentage of oxygen to fall below the 5% threshold to cause the slaughter of the animals within a predetermined time.

Advantageously, the method according to the present invention allows, in compliance with the recommended standards for animal welfare, to minimize the typical convulsive phenomena of the slaughter procedure by means of the use of gas or pressure reduction (LAPS METHOD).

Advantageously, by virtue of the method for stunning and killing of animals according to the present invention, the slaughtered animals do not manifest damage due to convulsive phenomena as often happens during the use of the LAPS method.

Advantageously, the periods required for the entire slaughter cycle are reduced because the slaughter-by-aspiration step is exploited in order to discharge the mixture of air and gas present within the chamber safely and away from the workplaces.

In summary, the method for stunning and killing of animals according to the present invention has proved to be very useful for:
1—substantially reducing the damage caused by convulsions typical of the L.A.P.S., L.A.P.S.+Gas slaughter methods;
2—reducing the amount of gas used and the slaughtering times of animals compared to GAS slaughter method.

Advantageously, by virtue of the method for stunning and killing of animals according to the present invention, in the event that the pre-aspiration step is performed, a gas saving is also obtained because it is sufficient to insert less gas (proportional to the volume of air within the chamber) in order to obtain the loss of consciousness, at least partially, of the animals that are within a chamber with an already rarefied atmosphere.

The killing according method to the present invention is suitable for all conditions of use a defined by the legislation concerning the protection of animals during slaughter (Council Regulation (EC) No 1099/2009 of 24 Sep. 2009).

To the method according to the present invention, a person skilled in the art, in order to meet contingent and specific make additional requirements, may modifications and variations, all of which, however, are contained within the scope of protection of the invention as defined by the following claims.

What is claimed is:

1. A method for stunning and killing animals, suitable for poultry, pigs, chinchillas, mustelids, rabbits, and fur-bearing animals, the method comprising:
introducing live animals to be killed into a sealed chamber of a slaughter plant;
adding to the sealed chamber at least one gas adapted to cause the animals to lose consciousness;
performing a stunning stop so that the animals in the sealed chamber are at least partially stunned;
creating a vacuum inside the sealed chamber until a predetermined killing pressure is achieved;
performing a killing stop so that the stunned animals in the sealed chamber are killed;
opening the sealed chamber and extracting the killed animals.

2. The method of claim 1, further comprising, after the step of introducing the live animals into the sealed chamber and before the step of adding the at least one gas adapted to cause the animals to lose consciousness to the sealed chamber, a pre-suction step which includes:
creating a vacuum inside the sealed chamber until a predetermined internal pressure is achieved.

3. The method of claim 1, wherein the at least one gas adapted to cause stunning of the animals is carbon dioxide or carbon dioxide associated with inert gases, and the amount of added gas is between 10% and 60% of the volume (lt) of air in the sealed chamber.

4. The method of claim 3, wherein:
if a pre-suction step is performed, the percentage of gas to be introduced is between 30% and 50% of the volume (lt) of air present in the sealed chamber;
in the absence of the pre-suction step, the percentage of gas to be introduced is between 20% and 40% of the volume (lt) of air present in the sealed chamber.

5. The method of claim 1, wherein the stunning stop is between 10 seconds and 10 minutes.

6. The method of claim 5, wherein:
if a pre-suction step is performed, the stunning stop is between 30 seconds and 2 minutes;
in the absence of the pre-suction step, the stunning stop is between 10 seconds and 2 minutes.

7. The method of claim 1, wherein the killing pressure is between 33 kPa (250 Torr) and 12 kPa (90 Torr).

8. The method of claim 1, wherein the killing stop is between 10 seconds and 180 seconds.

9. The method of claim 2, wherein the pre-suction step includes sucking air until an internal pressure between 99 KPa (750 Torr) and 26 kPa (200 Torr) is obtained.

10. The method of claim 3, wherein the amount of added gas is between 20% and 50% of the volume (lt) of air in the sealed chamber.

11. The method of claim 2, wherein the pre-suction step includes sucking air until an internal pressure between 87 KPa (650 Torr) and 60 kPa (450 Torr) is obtained.
